(19) United States
(12) Patent Application Publication
(10) Pub. No.: US 2026/0166457 A1
(43) Pub. Date: Jun. 18, 2026

(54) FILTER ELEMENT AND AN ENDPLATE FOR A FILTER ELEMENT

(71) Applicant: Atmus Filtration (Shanghai) Co., Ltd., Shanghai (CN)

(72) Inventors: Xiaohaun Xia, Wuhan (CN); Yiyun Zhang, Shanghai (CN); Ruhui Huang, Wuhan (CN); Yan Cheng, Wuhan (CN)

(21) Appl. No.: 19/416,254

(22) Filed: Dec. 11, 2025

(30) Foreign Application Priority Data
Dec. 17, 2024 (CN) 202411873112.8
Dec. 17, 2024 (CN) 202423133081.0

(51) Int. Cl. B01D 35/30; B01D 29/15

(52) U.S. Cl. CPC B01D 35/30; B01D 29/15; B01D 2201/16; B01D 2201/291; B01D 2201/347

(57) ABSTRACT

The application relates to an endplate for a filter element. A filter element includes a filter media and an endplate positioned at a first end of the filter media. The endplate includes an end wall defining an aperture. The endplate includes an axial flange extending from the end wall in a direction away from the filter media. The axial flange has a first portion positioned at a first radial distance from the aperture and a second portion positioned at a second radial distance from the aperture, less than the first radial distance. The endplate includes a sealing member positioned around the axial flange such that the sealing member contacts at least the first portion of the axial flange.

### CROSS-REFERENCE TO RELATED APPLICATIONS

This application is a Paris Convention filing of, and claims priority to, both of Chinese Invention Patent Application Serial No. 202411873112.8 filed Dec. 17, 2024, and Chinese Utility Model Application Serial No. 202423133081.0 filed Dec. 17, 2024, the entire contents of both of which are hereby incorporated by reference herein.

### FIELD

This disclosure relates to an endplate for use in a filter element. The filter element may be used in filtration systems.

### BACKGROUND

Filtration systems may be used to separate contaminates from a fluid to protect downstream devices from damage (e.g., corrosion, clogging, etc.). For example, filtration systems may protect downstream devices by including a filter element to separate contaminants form the fluid that may damage the downstream devices.

### SUMMARY

Various embodiments provide for a filter element. The filter element includes a filter media and an endplate positioned at a first end of the filter media. The endplate includes an end wall defining an aperture. The endplate includes an axial flange extending from the end wall in a direction away from the filter media. The axial flange has a first portion positioned at a first radial distance from the aperture and a second portion positioned at a second radial distance from the aperture, less than the first radial distance. The endplate includes a sealing member positioned around the axial flange such that the sealing member contacts at least the first portion of the axial flange.

In some embodiments, the endplate further comprises a valve assembly extending from the end wall in a direction away from the filter media; and the second portion of the axial flange is positioned proximate the valve assembly.

In some embodiments, a shape of the axial flange is a circular segment, and wherein the first portion is positioned along an arc of a circular segment and the second portion is positioned along a chord of the circular segment.

In some embodiments, a depth of the chord is between about 1 millimeter (mm) and about 2 mm, inclusive, wherein the depth of the cord is a difference between the first radial distance and the second radial distance.

In some embodiments, the depth of the chord is about 1.3 mm.

In some embodiments, the sealing member is a radial seal member positioned on an outer periphery of the endplate.

In some embodiments, the endplate is an upper endplate; and the filter element includes a lower endplate positioned at a second end of the filter media, opposite the first end of the filter media.

In some embodiments, the endplate includes a radial flange extending radially outward from a distal end of the axial flange; the axial flange is positioned radially inward from an outer periphery of the end wall; the radial flange, the axial flange, and the outer periphery of the end wall cooperate to define a sealing channel; and the sealing member is at least partially positioned within the sealing channel.

In some embodiments, a gap is defined between the sealing member and the second portion of the axial flange, the gap allowing air to travel axially past the sealing member.

Various other embodiments provide for a filtration system. The filtration system includes a filter housing and a filter element. The filter element includes a filter media and an endplate positioned at a first end of the filter media. The endplate includes an end wall defining an aperture. The endplate includes an axial flange extending from the end wall in a direction away from the filter media. The axial flange has a first portion positioned at a first radial distance from the aperture and a second portion positioned at a second radial distance from the aperture, less than the first radial distance. The endplate includes a sealing member positioned around the axial flange such that the sealing member contacts at least the first portion of the axial flange. The sealing member is positioned between the filter housing and the axial flange. The sealing member is configured to form a seal at least partially therebetween.

Various other embodiments provide for an endplate for a filter element. The endplate includes an end wall defining an aperture. The endplate includes an axial flange extending from the end wall in a first direction away from the filter media. The axial flange has a first portion positioned at a first radial distance from the aperture and a second portion positioned at a second radial distance from the aperture, less than the first radial distance. The endplate includes a sealing member positioned around the axial flange such that the sealing member contacts at least the first portion of the axial flange.

In some embodiments, the endplate further comprises a valve assembly extending outward from the end wall in the first direction; and the second portion of the axial flange is positioned proximate the valve assembly.

In some embodiments, a shape of the axial flange is a circular segment, and wherein the first portion is positioned along an arc of a circular segment and the second portion is positioned along a chord of the circular segment.

In some embodiments, the endplate includes a radial flange extending radially outward from a distal end of the axial flange; the axial flange is positioned radially inward from an outer periphery of the end wall; the radial flange, the axial flange, and the outer periphery of the end wall cooperate to define a sealing channel; and the sealing member is at least partially positioned within the sealing channel.

In some embodiments, a gap is defined between the sealing member and the second portion of the axial flange, the gap allowing air to travel axially past the sealing member.

### BRIEF DESCRIPTION OF DRAWINGS

The present disclosure is described in detail below with reference to the attached drawing figures. The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1 is a side view showing a filtration system, according to an example embodiment.

FIG. 2 is a cross-sectional view of the filtration system of FIG. 1.

FIG. 3 is a perspective view of an endplate usable with the filtration system of FIG. 1.

FIG. 4 is another perspective view of the endplate of FIG. 3.

Reference is made to the accompanying drawings throughout the following detailed description. In the drawings, similar symbols typically identify similar components unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Various embodiments now will be described more fully hereinafter with reference to the accompanying drawings, which form a part hereof, and which show, by way of illustration, specific embodiments. However, this invention may be embodied in many different forms and should not be construed as limited to the embodiments set forth herein. Rather, these embodiments are provided so that this disclosure will be thorough and complete, and will fully convey the scope of the invention to those skilled in the art. The following detailed description is not to be taken in a limiting sense.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments may be readily combined without departing from the scope or spirit of the present disclosure.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Referring to the Figures generally, various embodiments disclosed herein relate to an endplate for a filter element, which may be included in a filtration system. The endplate advantageously includes an air vent that allows air to flow therethrough. For example, during operation of the filtration system, a fluid, such as fuel, oil, etc., may flow through a filter media of the filter element. Air entrained in the fluid may not easily pass through the filter media and become “trapped” upstream of the filter media. Advantageously, early in the service life of the filter media, the air may pass through the air vent, rather than passing through the filter media such that the air is allowed to escape the filtration system. Later in the service life of the filter media, contaminants trapped within the filter media may reduce the fluid flow rate through the filter media, which will increase fluid levels within the filter shell. In turn, the gasket around air vent will swell and seal the vent, which may mitigate (e.g., decrease) any reduction in fuel filtration efficiency.

The embodiments shown and described in further detail herein relate to an outside-in flow design for a filtration system. It should be understood that the embodiments described herein may be utilized in other filtration system arrangements. For example, the embodiments described herein may be utilized in an inside-out flow design and/or any other type of filtration systems. Additionally, the filtration system may include more or fewer components than as shown in the Figures. Accordingly, references to various components being within, downstream, exterior, upstream, and the like are relative to the embodiments shown in Figures, and it should be understood that other embodiments, such as an inside-out flow design for a filtration system, may have the same or similar components provided in a different arrangement.

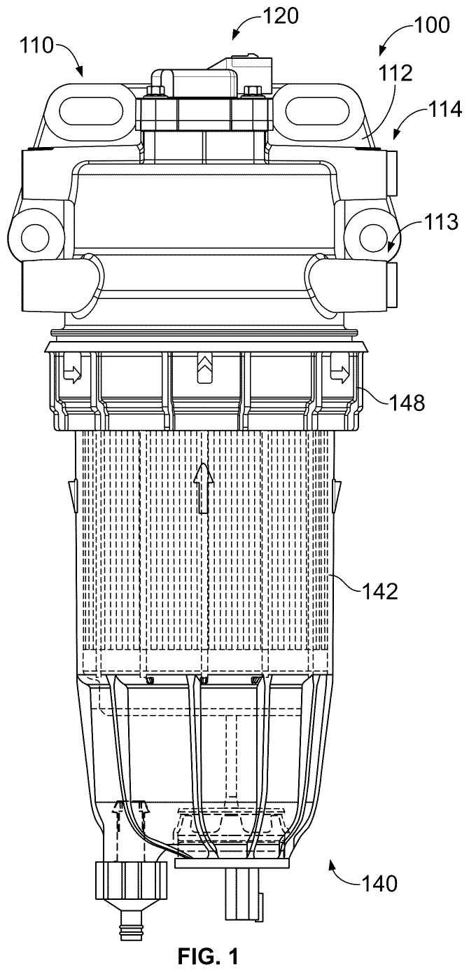

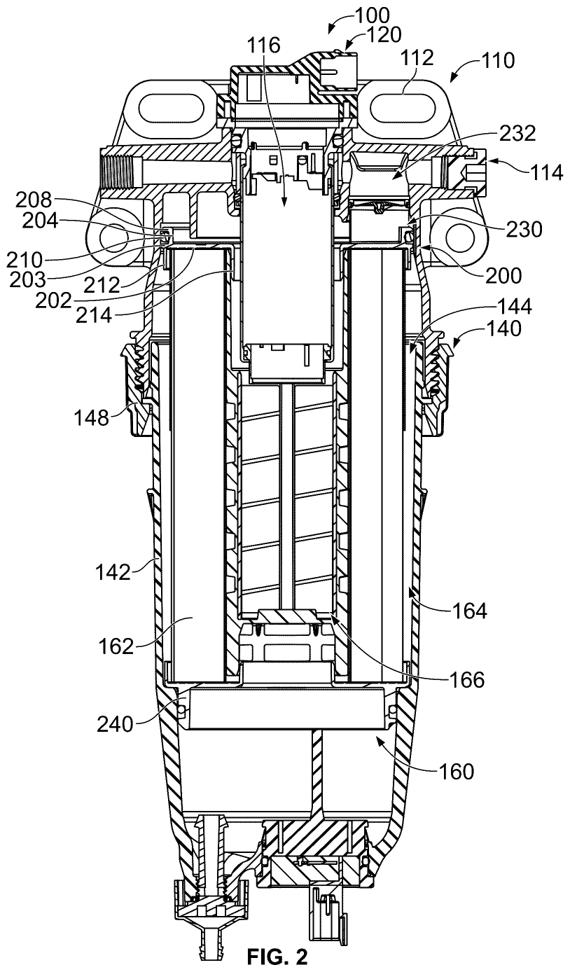

Now referring to FIGS. 1 and 2, a filtration system 100 is shown, according to an example embodiment. It should be understood that the filtration system 100 may include more or fewer components than as shown in FIGS. 1 and 2. The filtration system 100 is configured to receive an unfiltered fluid (e.g., fuel, oil, etc.), filter the fluid, and provide the filtered fluid to a downstream device, such as an engine. As shown, the filtration system 100 includes a filter head 110 and a filter cartridge 140. The filter cartridge 140 is configured to be coupled to the filter head 110.

The filter head 110 includes a filter head body 112. The filter head body 112 defines one or more ports, shown as a first port 113 and a second port 114. The first port 113 is an inlet port in fluid receiving communication with an upstream device and in fluid providing communication with an interior of the filtration system 100. The second port 114 is an outlet port in fluid receiving communication with an interior of the filtration system 100 and in fluid providing communication with a downstream device, such as an engine. In other embodiments, the first port is configured as the outlet port and the second port 114 is configured as the inlet port.

The filter head body 112 defines a central port 116. The central port 116 extends through the filter head body 112. The central port 116 is centered on a center axis of the filtration system 100. The center axis extends through a radial center of the filtration system 100, a center of the filter head 110, and/or a center of the filter cartridge 140.

As used herein, the term “axis” describes a theoretical line extending through at least a portion of an object, such as a centroid (e.g., center of mass, geometric center, etc.) of an object. In some arrangements, the object is centered on the axis. The object is not necessarily cylindrical (e.g., a non-cylindrical shape may be centered on an axis, etc.). Furthermore, the object is not necessarily on the axis (e.g., a centroid of a hollow object may be on the axis, but no portion of the object needs to be on the axis).

As shown in FIG. 2, a pump 120 may be coupled to the filter head 110. For example, the pump 120 may be configured to pump a fluid, such as fuel, through the filtration system 100. In the embodiment of FIG. 2, the pump 120 is electrically driven.

The pump 120 is at least partially positioned within the central port 116. That is, the central port 116 is positioned to receive the at least a portion of the pump 120 therein. The pump 120 is configured to create a pressure differential within the filtration system 100, thereby drawing fluid in an outside-in flow configuration.

The filter cartridge 140 includes a shell 142 and a filter element 160. The shell 142 at least partially defines an internal volume 144. The filter head 110 also at least partially defines the internal volume 144. The filter element 160 is positioned at least partially within the internal volume 144 such that the filter element 160 is within the filter head 110 and the shell 142.

The filtration system 100 includes a collar 148. The collar 148 couples the filter cartridge 140, and more particularly the shell 142, to the filter head 110.

The filter element 160 is configured to filter the fluid (e.g., by removing contaminants). In some embodiments, the filter element 160 is removably coupled to the shell 142. In other embodiments, the filter element 160 is permanently secured within the shell 142 such that the filter element 160 cannot be removed from the shell 142 without causing damage to the filter element 160 and/or the shell 142. The filter element 160 is at least partially contained within the shell 142 and/or the filter head 110.

The filter element 160 includes a filter media 162. The filter media 162 may be positioned between and may be coupled to one or more endplates, shown as a first endplate 200 and a second endplate 240. The filter media 162 is formed in a cylindrical or annular configuration. The filter media 162 may be pleated to increase surface area. The filter media 162 may be a single-layer media or a multi-layer media made from at least one of a woven fiber, a non-woven material, a wet laid material, a polymeric material, a glass material, a cellulose material, and/or other suitable material. The filter media 162 is structured to allow the unfiltered fluid to be filtered by flowing through the filter media 162. For example, the unfiltered fluid flows through the filter media 162, and the filter media 162 removes impurities, such as particulates, organic matter, and the like, from the unfiltered fluid as the unfiltered fluid passes through the filter media 162. The impurities are trapped by the filter media 162. An outer volume 164 is defined between the filter media 162 and the shell 142. An inner volume 166 is defined within the filter media 162. In operation, a fluid flows from the outer volume 164, through the filter media 162, and into the inner volume 166.

The filter element 160 includes the first endplate 200. In the embodiment shown, the first endplate 200 is a an upper endplate that is positioned at a first end of the filter media 162, proximate the filter head 110. The filter element 160 includes the second endplate 240 (e.g., a lower endplate), that is positioned at a second end of the filter media 162, opposite the first end of the filter media 162.

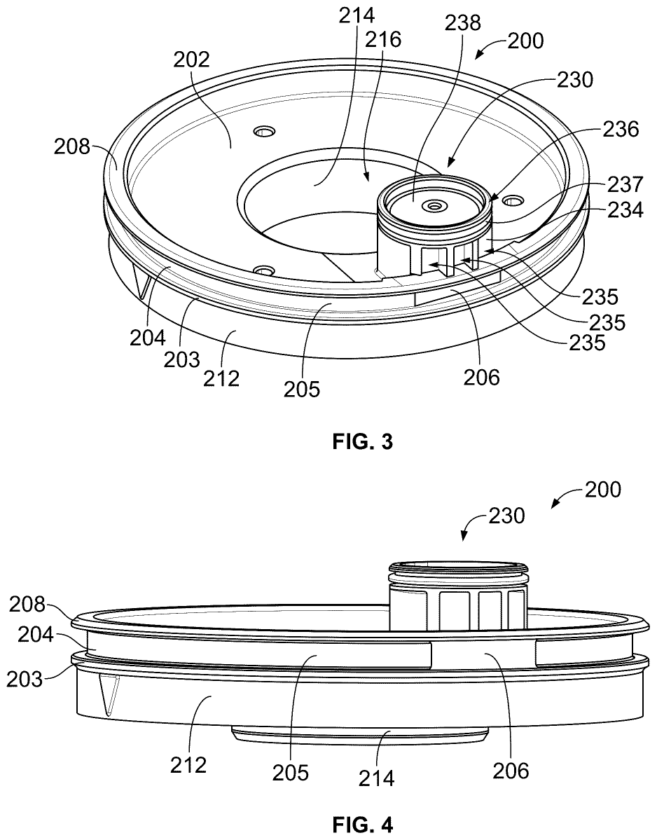

As shown in FIGS. 2-3, the endplate 200 includes an end wall 202. The end wall 202 extends radially outward relative to the center axis of the filtration system 100.

As shown in FIG. 3, the end wall 202 at least partially defines an aperture 216. In some embodiments, the aperture 216 is centered on the center axis of the filtration system 100, such that the aperture 216 is aligned with the central port 116. When the pump 120 is included in the filtration system 100, as shown in FIG. 2, the pump 120 extends though the aperture 216.

The first endplate 200 includes an axial flange 204. The axial flange 204 extends from the end wall 202 in a direction away from the filter media 162. As shown in FIG. 4, the axial flange 204 has a first portion 205 that is positioned at a first radial distance from the aperture 216 and a second portion 206 that is positioned at a second radial distance from the aperture 216, less than the first radial distance.

In some embodiments, a shape of the axial flange 204 is a “circular segment.” As described herein the shape of a “circular segment” is defined by an arc of the circular segment and a chord of the circular segment. The first portion 205 of the axial flange 204 is positioned along the arc of a circular segment. The second portion 206 of the axial flange 204 is positioned along the chord of the circular segment.

The first radial distance is a radius of the circular segment. For example, the first radial distance may be the distance between a center of the circular segment (e.g., the center of the end wall 202 and/or the center axis of the filtration system 100) and the first portion 205 of the axial flange 204.

The second radial distance is a length of an apothem of the circular segment. The apothem of the circular segment is defined as a theoretical line segment that extends between the center of the circular segment (e.g., the center of the end wall 202 and/or the center axis of the filtration system 100) and the midpoint of the chord of the circular segment (e.g., the midpoint of the second portion 206 of the axial flange 204).

In some embodiment, the axial flange 204 is formed by forming a circular or substantially circular ring that extends from the end wall 202. Then, a portion of the axial flange 204 is removed (e.g., via a cutting process, a machining process, etc. to remove material from the axial flange 204). The portion of the axial flange 204 that is removed is substantially parallel to a theoretical tangent line that is tangent to the formed circle. Thus, the removal of the material forms an arc (e.g., the uncut portion of the axial flange 204, referred to as the first portion 205) and a chord (e.g., the cut portion of the axial flange 204, referred to as the second portion 206). In other embodiments, the axial flange 204 is formed in the shape of the above-described circular segment.

A distance between the circular shape of the axial flange 204 and the chord referred to as a “depth” of the chord. In some embodiments, the “depth” of the chord may be defined as a difference between the first radial distance and the second radial distance. In other embodiments, the “depth” of the chord is defined by a diameter and a “height” of the circular segment. For example, as shown in FIG. 4, the arc of the circular segment is a major arc that subtends an angle greater than π radians. As such, a sagitta (e.g., the distance from the midpoint of the arc to the midpoint of the chord), also referred to as the “height” of the circular segment, is greater than the radius of the circular segment. In these embodiments, the “depth” of the chord is defined as the diameter of the circular segment minus the height of the circular segment.

In any of the above-described embodiments, the depth of the chord may be between about 1 millimeter (mm) and about 2 mm, inclusive. For example the “depth” of the chord may be about 1.3 mm.

In some embodiments, the first endplate 200 includes a radial flange 208 that extends radially outward from a distal end of the axial flange 204. The distal end of the axial flange 204 is positioned away from the end wall 202. As such, the radial flange 208 is spaced away from the end wall 202. Additionally, the axial flange 204 is positioned radially inward from an outer periphery 203 of the end wall 202. That is, the outer periphery 203 of the end wall 202 is a portion of the end wall 202 that is radially outward of the axial flange 204 and defines an outer perimeter of the end wall 202. In some embodiments, the radial flange 208, the axial flange 204, and the outer periphery 203 of the end wall 202 cooperate to define a sealing channel.

The filter element 160 includes a sealing member 210 (e.g., an O-ring, a gasket, etc.). As shown in FIG. 2, the sealing member 210 positioned around the axial flange 204 such that the sealing member 210 contacts at least the first portion 205 of the axial flange 204. For example, the sealing member 210 may be a radial seal member that is positioned on an outer periphery of the first endplate 200. In some embodiments, the sealing member 210 is at least partially positioned within the sealing channel defined by the radial flange 208, the axial flange 204, and the outer periphery 203 of the end wall 202.

As shown in FIG. 2, the sealing member 210 is positioned between the filter head 110 and the filter element 160. The sealing member 210 engages the filter head 110 and the filter element 160 and at least partially forms a radially directed seal therebetween. More specifically, the sealing member 210 is at least partially compressed between the filter head 110 and the axial flange 204 of the first endplate 200, such that the sealing member 210 forms the radially directed seal where the sealing member 210 is compressed.

In some embodiments, a gap is defined between the sealing member 210 and the second portion 206 of the axial flange 204. For example, because of the variable geometry of the axial flange 204 (e.g., the radial position of the first portion 205 relative to the radial position of the second portion 206, described above), the sealing member 210 is not fully compressed between the filter head 110 and the axial flange 204, resulting in the gap between the sealing member 210 and the second portion 206 of the axial flange 204. The gap allows air to travel axially past the sealing member 210 (e.g., between the sealing member 210 and the second portion 206 of the axial flange 204).

During operation of the filtration system 100, air within the outer volume 164 may become trapped upstream of the filter media 162. Advantageously, the gap formed between the sealing member 210 and the second portion 206 of the axial flange 204 allows air to travel axially past the sealing member 210. When the air flows through the gap between the sealing member 210 and the second portion 206 of the axial flange 204, the air may flow into the port 114 and out of the filtration system 100.

The first endplate 200 includes an outer skirt 212 and an inner skirt 214. The outer skirt 212 that extends from the end wall 202 in a direction towards the filter media 162. The outer skirt 212 extends from the end wall 202 proximate the outer periphery 203 of the end wall 202. The inner skirt 214 extends from the end wall 202 in a direction towards the filter media 162 (e.g., parallel to or substantially parallel to the outer skirt 212). The inner skirt 214 extends from the end wall 202 proximate aperture 216, such that the inner skirt 214 at least partially defines the aperture 216.

As shown in FIGS. 2-4, the first endplate 200 includes a valve assembly 230. The valve assembly 230 extends outward from the end wall 202 in the direction away from the filter media 162. As shown in FIG. 2, the valve assembly 230 extends into a valve chamber 232. The valve chamber 232 is at least partially defined by the filter head body 112. The valve chamber 232 is in fluid communication with the port 114. As shown in FIG. 3, the valve assembly 230 includes a valve body 234, a valve assembly sealing surface 236, and a valve 238 (e.g., a check valve, a one way valve, etc.).

The valve body 234 extend axially away from the first endplate end wall 202 in a direction away from the filter media 162. More specifically, the valve body 234 extends toward the valve chamber 232 such that at least a portion of the valve body 234 is within the valve chamber 232.

The valve body 234 defines one or more flow channels 235. For example, as shown in FIG. 3 the valve body 234 includes one or more walls that define the flow channels 235 therebetween. The flow channels 235 enable fluid communication between the inner volume 166 and the valve 238. As shown in FIG. 3, the flow channels 235 extend through the valve body 234. For example, during operation, a fluid that is within the inner volume 166 may flow through the aperture 216 and into the valve body 234, via the flow channels 235.

The valve assembly sealing surface 236 extends around a periphery of the valve body 234. As shown in FIG. 3, the valve assembly sealing surface 236 is a channel defining an open end that is directed radially outward. The valve assembly sealing surface 236 (e.g., the channel) is sized to receive a sealing member 237. The valve assembly sealing surface 236 supports the sealing member 237. The sealing member 237 engages the valve assembly sealing surface 236 and an inner surface of the valve chamber 232 to form a radially directed seal therebetween. The seal prevents a fluid from flowing between the valve assembly 230 and the valve chamber 232.

The valve 238 is coupled to the valve body 234. The valve 238 selectively enables fluid communication between inner volume 166 and the second port 114. More specifically, the valve 238 selectively enables fluid communication between inner volume 166 and the second port 114 via one or more of the aperture 216, the flow channels 235, and the valve chamber 232. In some embodiments, the valve 238 is a check valve or a one-way valve that selectively operable between a first position (e.g., an open position) whereby the valve 238 enables a fluid to flow from the inner volume 166 to the second port 114 and a second position (e.g., a closed position) whereby the valve 238 substantially prevents a fluid from flowing through the valve body 234. However, it should be understood that, in other embodiments, such as an outside-in flow configuration, the valve 238 may enable a fluid to flow from the second port 114 to the inner volume 166 in the first position, while still preventing a fluid from through the valve body 234 in the second position.

As shown in FIG. 4, the second portion 206 of the axial flange 204 is positioned proximate the valve assembly 230. In this way, the gap between the sealing member 210 and the second portion 206 of the axial flange 204 allows air to travel axially past the sealing member 210 and into the port 114. For example, the air may travel through the gap between the sealing member 210 and the second portion 206 of the axial flange 204 and into the port 114 via the valve chamber 232.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges, relationships, or descriptions provided. Accordingly, these terms should be interpreted as indicating that insubstantial or inconsequential modifications or alterations of the subject matter described and claimed are considered to be within the scope of the disclosure as recited in the appended claims. The term “coupled” and the like as used herein mean the joining of two members directly to one another. Such joining may be stationary (e.g., permanent) or moveable (e.g., removable or releasable).

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, various parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the concepts presented herein.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A filter element, comprising:
a filter media; and
an endplate positioned at a first end of the filter media, the endplate comprising:
an end wall defining an aperture;
an axial flange extending from the end wall in a direction away from the filter media, the axial flange having a first portion positioned at a first radial distance from the aperture and a second portion positioned at a second radial distance from the aperture, less than the first radial distance; and
a sealing member positioned around the axial flange such that the sealing member contacts at least the first portion of the axial flange.

2. The filter element of claim 1, wherein the endplate further comprises a valve assembly extending from the end wall in a direction away from the filter media, and the second portion of the axial flange is positioned proximate the valve assembly.

3. The filter element of claim 1, wherein a shape of the axial flange is a circular segment, and the first portion is positioned along an arc of the circular segment and the second portion is positioned along a chord of the circular segment.

4. The filter element of claim 3, wherein a depth of the chord is between about 1 mm and about 2 mm, inclusive, wherein the depth of the cord is a difference between the first radial distance and the second radial distance.

5. The filter element of claim 4, wherein the depth of the chord is about 1.3 mm.

6. The filter element of claim 1, wherein the sealing member is a radial seal member positioned on an outer periphery of the endplate.

7. The filter element of claim 1, wherein:
the endplate is an upper endplate; and
the filter element includes a lower endplate positioned at a second end of the filter media, opposite the first end of the filter media.

8. The filter element of claim 1, wherein:
the endplate includes a radial flange extending radially outward from a distal end of the axial flange;
the axial flange is positioned radially inward from an outer periphery of the end wall;
the radial flange, the axial flange, and the outer periphery of the end wall cooperate to define a sealing channel; and
the sealing member is at least partially positioned within the sealing channel.

9. The filter element of claim 1, wherein a gap is defined between the sealing member and the second portion of the axial flange, the gap allowing air to travel axially past the sealing member.

10. A filtration system, comprising:
a filter housing; and
the filter element of claim 1, wherein the sealing member is positioned between the filter housing and the axial flange, the sealing member forming a seal at least partially therebetween.

11. An endplate for a filter element, comprising:
an end wall defining an aperture;
an axial flange extending from the end wall in a first direction away from the filter media, the axial flange having a first portion positioned at a first radial distance from the aperture and a second portion positioned at a second radial distance from the aperture, less than the first radial distance; and
a sealing member positioned around the axial flange such that the sealing member contacts at least the first portion of the axial flange.

12. The endplate of claim 11, wherein:
the endplate further comprises a valve assembly extending outward from the end wall in the first direction; and
the second portion of the axial flange is positioned proximate the valve assembly.

13. The endplate of claim 11, wherein:
a shape of the axial flange is a circular segment;
the first portion is positioned along an arc of a circular segment; and
the second portion is positioned along a chord of the circular segment.

14. The endplate of claim 11, wherein:
the endplate includes a radial flange extending radially outward from a distal end of the axial flange;
the axial flange is positioned radially inward from an outer periphery of the end wall;
the radial flange, the axial flange, and the outer periphery of the end wall cooperate to define a sealing channel; and
the sealing member is at least partially positioned within the sealing channel.

15. The endplate of claim 11, wherein a gap is defined between the sealing member and the second portion of the axial flange, the gap allowing air to travel axially past the sealing member.
